(19) United States
(12) Patent Application Publication
(10) Pub. No.: US 2018/0356973 A1
(43) Pub. Date: Dec. 13, 2018

(54) Method And System For Enhanced Touchscreen Input And Emotional Expressiveness

(71) Applicant: Michael Callahan, San Francisco, CA (US)

(72) Inventor: Michael Callahan, San Francisco, CA (US)

(21) Appl. No.: 16/007,736

(22) Filed: Jun. 13, 2018

Related U.S. Application Data
(60) Provisional application No. 62/518,857, filed on Jun. 13, 2017.

(51) Int. Cl. G06F 3/0488; H04L 12/58

(52) U.S. Cl. CPC G06F 3/04883; H04L 51/10

(57) ABSTRACT

Systems and methods are provided for enhanced touchscreen input and emotional expressiveness and may include, in a handheld communication device comprising a user input mechanism, a processor, and a display: receiving textual information in a message window via the user input mechanism; entering an alternative information entry screen based on a swipe across the user input mechanism; and inserting one or more elements of visual information into the message window based on a user selection. The alternative information entry screen may comprise a camera, graphics interface exchange (GIF), emoji, video library, audio clip, or photo library entry screen, which may be selected based on a direction of the swipe across the user input mechanism. The device may switch back to textual information entry mode in the message window when the user input mechanism senses an opposite direction swipe by the user.

### CROSS-REFERENCE TO RELATED APPLICATIONS/INCORPORATION BY REFERENCE

This application claims priority to and the benefit of U.S. Provisional Application 62/518,857 filed on Jun. 13 2017, which is hereby incorporated herein by reference in its entirety.

### TECHNICAL FIELD

Aspects of the present disclosure relate to communication. More specifically, certain implementations of the present disclosure relate to methods and systems for enhanced touchscreen input and emotional expressiveness.

### BACKGROUND

Conventional approaches for keyboard mode transitions may be costly, cumbersome, and/or inefficient—e.g., they may be complex and/or time consuming.

Further limitations and disadvantages of conventional and traditional approaches will become apparent to one skilled in the art, through comparison of such systems with some aspects of the present disclosure as set forth in the remainder of the present application with reference to the drawings.

### BRIEF SUMMARY

System and methods are provided for enhanced touchscreen input and emotional expressiveness, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating handheld communication device, in accordance with an example embodiment of the disclosure.

FIG. 2 is a block diagram illustrating touchscreen keyboard directional swiping, in accordance with an example embodiment of the disclosure.

FIG. 3 is a flow chart for touchscreen keyboard directional swiping, in accordance with an example embodiment of the disclosure.

FIG. 4 illustrates a text entry screen with visual return buttons and mood indication, in accordance with an example embodiment of the disclosure.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry or a device is “operable” to perform a function whenever the circuitry or device comprises the necessary hardware and code (if any is necessary) to perform the function, regardless of whether performance of the function is disabled or not enabled (e.g., by a user-configurable setting, factory trim, etc.).

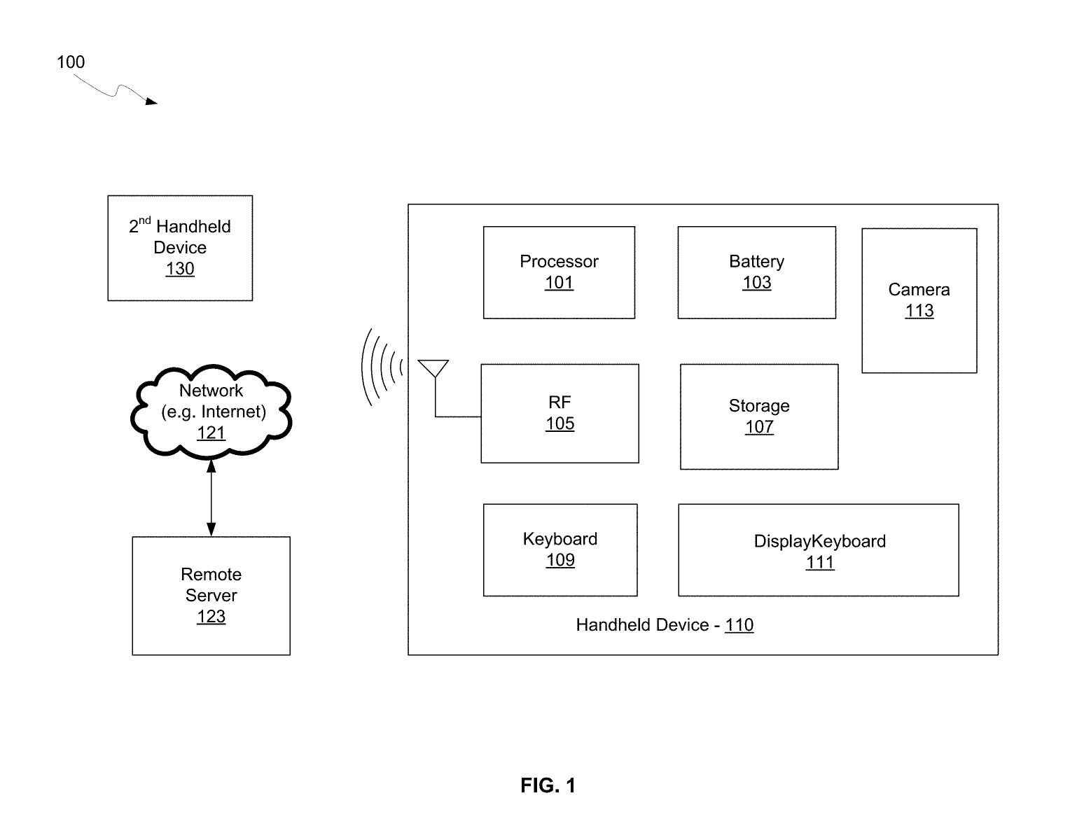

FIG. 1 is a diagram illustrating handheld communication device, in accordance with an example embodiment of the disclosure. Referring to FIG. 1, there is shown a communication system 100 with a handheld device 110, a network 121, an optional remote server 123, and a 2^{nd} handheld device 130. The handheld device 110 may comprise any device used for communication such as a cell phone, tablet, or laptop computer, for example, with computing and storage capability, although some of such capability may be performed by other devices in communication with the handheld device 110.

The handheld device 110 may comprise a processor 101, a battery 103, a wireless radio frequency (RF) front end 105, storage 107, an optional physical keyboard, a display 111, which may provide the keyboard for the handheld device 110 if no physical keyboard, and a camera 113.

The processor 101 may control the operations of the handheld device 110, storing information in the storage 107, enabling communications via the RF front end 105, processing information received via display/the keyboard 111, and other suitable control operations for the handheld device 110. With respect to the display/keyboard 111, the processor 101 may receive input indicating when a user touches the screen, such as tapping or swiping on the display/keyboard 111, and perform steps as indicated by the user input.

The battery 103 may provide power for the handheld device 110 and the storage 107 may comprise a memory device for storing information. In an example scenario, the storage 107 may store operating system files, user data such as images, music, and textual information. The storage 107 may also store photos taken by the camera 113 and small digital icons or images, i.e., emojis, for example.

The RF front end 105 may comprise suitable circuitry for communicating wirelessly with other devices via one or more networks, such as the network 121. The RF front end 105 may therefore communicate utilizing various communications standards, such as GSM, CDMA, WiFi, Bluetooth, Zigbee, etc., and therefore may comprise one or more antennae, filters, amplifiers, mixers, and analog-to-digital converters, for example.

The handheld device 110 may comprise a physical keyboard 109, and a touchscreen display/keyboard 111, for entering information, such as through text messaging. The display/keyboard 111 comprises a combination of display and touch sensing capability with display pixels, such as backlit liquid crystal displays, and a transparent touch sensing grid on top.

The camera 113 may comprise one or more imaging sensors and optics for focusing light onto the sensors, and may be operable take pictures through operation of the user of the handheld device 100. In typical mobile phone operating systems, the camera 113 is enabled via a selection button on a home screen, or from a pop-up screen selection.

The network 121 may comprise any communication network by which the handheld device communicates with other devices, such as the remote server 123 and the 2^{nd} handheld device 130. As such, the network 121 may comprise the Internet, a local WiFi network, one or more cellular networks, etc.

The remote server 123 may comprise a computing device or devices for assisting in storing or processing data for the handheld device 110. The remote server may be optional in instances when the storage is sufficient locally on the handheld device 130.

The display/keyboard 111 may be utilized to enter data, such as text, images, and other visual input for messaging to the second handheld device 130. Existing methods of switching between different input modes, e.g., between text, emojis, camera, and photos, for example, are difficult requiring a user to select a small key on the touchscreen keyboard when typing.

In an example embodiment, a swiping motion across the keys of the touchscreen keyboard may be utilized to activate an alternative information entry screen for different input mechanisms or modes. For example, a swipe to the right across the keyboard may switch the input mode to an array of GIFs that may be selected to include in the message being composed. Similarly, a swipe to the left may switch the input mode to an array of emojis to be selected, a swipe up may switch the device to its camera, whereas a swipe down may switch to the photo library stored on the mobile device 110 or remote server 123, for example.

Once an item has been selected from one of the other input modes, the text window may be re-selected by swiping back in the opposite direction as was used to enter the other input mode. For example, a user may swipe left to enter the emoji selection screen, select an emoji to insert into the message, and then swipe right to return to the text entry screen.

In a text messaging environment, there is a “back” button or arrow that is used to switch from the current message back to the list of other conversations. In an example scenario, a visual representation, such as an icon or photo etc., in the message itself may be displayed representing other conversations, for easier access, which may somewhere near the letter keys.

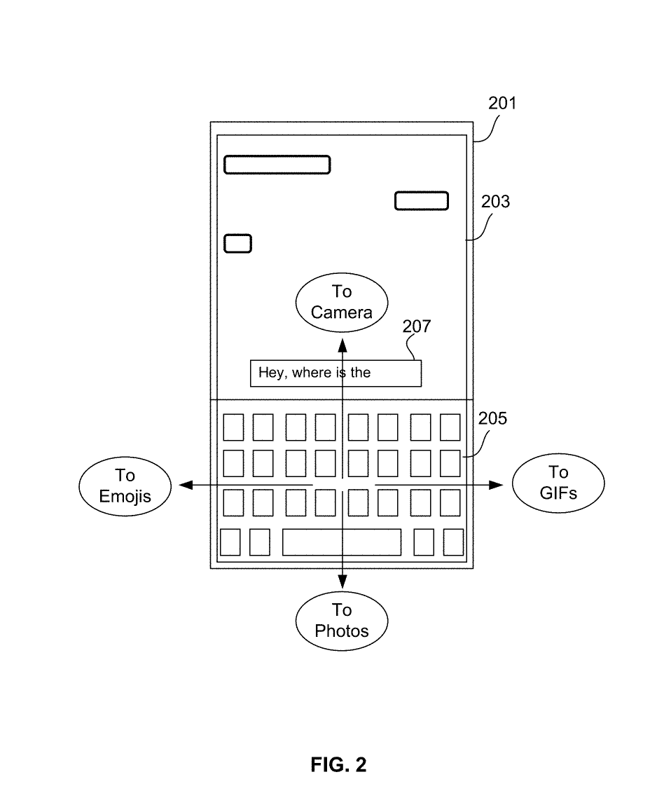

FIG. 2 is a block diagram illustrating touchscreen keyboard directional swiping, in accordance with an example embodiment of the disclosure. Referring to FIG. 2, there is shown handheld device 201 comprising a touchscreen/display 203, keyboard 205, and information entry window 207.

The handheld device 201 may share any and all features of the handheld device 100 described with respect to FIG. 1. The touchscreen/display 203 may comprise a touch sensitive device for interfacing with a user of the handheld device 201, and may comprise a display screen for presenting text and visual information. Accordingly, the touchscreen/display 203 comprises a combination of display and touch sensing capability with display pixels, such as backlit liquid crystal displays, and a transparent touch sensing grid, such as indium tin oxide for example, on top.

The keyboard 205 may comprise touch sensitive locations on the touchscreen/display for entering characters, and may include a QWERTY keyboard, for example, when in normal mode. The information entry window 207 may comprise a box in the touchscreen/display where information may be entered such as text, images, GIFs, and/or emojis, for example, that are to be communicated to an intended recipient. A visual representation, such as an icon or photo etc., in the message itself may be displayed representing other conversations, for easier access to other messages or recipients. This icon, photo, etc. may be located near near the letter keys

In operation, a user may wish to generate a message that includes textual information along with images, GIFs, and/or emojis, for example. The user may tap in the information entry window 207 and start to type a message using the keyboard 205. If the user wishes to take a picture of something nearby, the user may swipe upward in the area of the keyboard 205 to enter an alternative information entry screen, in this case a camera mode, on the handheld device 201. A picture or pictures may be taken and inserted into the message in the information entry window 207. The user may then swipe in the opposite direction, down in this case, to reenter the text entry mode. It should be noted that directional swiping may comprise more complex hand gestures than a simple movement in one direction to provide more media selection options, for example.

Additional inputs from the user, such as movements, of the device 201 may be utilized in order to modify the behavior of the device 201. For example, to communicate with someone in particular, a user may tap and hold the visual representation and bring the phone speakers and microphones near their mouth. In this case, the device would simultaneously know that the user wants to deliver a voice message and that the user wants the message to be sent to this particular person (or set of people). The accelerometer and the gyroscope may be utilized to detect the movement of the phone indicative of user gestures through the phone's movement, which changes the behavior of the action of pressing the button.

Another example for added gestures, in the prototype, if a user swipes up on the keyboard to get to the camera. Here, if a person holds their phone out and has their phone held vertically in their hand and press a visual representation of a conversation, it will open up the camera for the person(s) selected. Basically, the act of holding down a selected person/conversation and combining that with specific motion of the phone, is a fast way to indicate “I'm taking a picture to send to this person I've selected.” The picture/video/content could then be modified after that point as well. If no modification is desired, then it may be sent automatically to the person/people selected.

Similarly, if the user wishes to enter an emoji, the user may swipe left in the keyboard 205 to enter an alternative information entry screen, in this case an emoji selection screen, where one or more emojis may be selected and inserted into the message in the information entry window 207, then swipe right to return to the text entry window.

To enter a GIF or semantic visual image, the user may swipe to the right to enter a GIF selection window, where the user may select an appropriate GIF to be entered into the message and then swipe left to return to the text entry window.

Finally, to enter the photo library, the user may swipe downward and select one or more photos to be entered into the message being drafted, and may swipe upward to return to the text entry window.

It should be noted that while the four direction and resulting entry modes are shown in FIG. 2, the disclosure is not so limited, as other types of entry windows may be utilized, such as sound, video, etc. and in different directions, even in a diagonal direction. Similarly, other motions than a single linear swipe may be used, such as a circular motion, a “V” swiping motion, or an inverted V motion.

In another example scenario, a “mood” or “representation of emotion” visual aid may be incorporated on the display 203. For example, a heart or hearts may be inserted on the visual representation of a user in visual aid. Machine learning and statistical methods may be utilized to extract features from the user's text and compared with a lexicon of words or phrases that the machine has learned or are associated with certain emotions or emotional states. Thus, an analysis of the user's input may be made to determine the emotional state of the user. This may be displayed to the user and to other people as a passive way of expressing mood. For example, if a user is communicating with a person and was having a hard time, someone else who is close to the user could see that they are currently upset, which may impact how that person communicates or interacts with the user so as to not provide further distress.

In another example scenario, user input may be made using eye tracking for typing on mobile device. In this mode, a camera pointed at the user's face and/or eyes and identifies the directional gaze or the direction of the gaze of the user using either RGB data and/or depth data (such as from an infrared sensor) and then using the inferred direction (which comes from the pupil positioning and head positioning relative to the camera and device) identifying where a person is looking on the screen and using that input method for typing. The gaze would be directed at a key and the key would be registered similar to what is a keypress.

Another embodiment is where the person's gaze moves between letters and using word prediction in statistics the device 201 may infer what the person means to do. This can be used as an input method for characters and can also be used in a group of letters, for example, if some letters were grouped together on the screen in some way. Selecting methods may include the eye dwelling on something or staying there until a time threshold is crossed, eye blinking, forehead raise, or other expression. One embodiment may be a user blinking to simulate tapping or clicking something on screen.

Furthermore, browsing is another action that can be done with facial tracking. This could be in photos or any other content where the device 201 monitors the amount of attention that's been delivered to something and we metadata about that topic/thing the person is looking at, and such data may be used to populate more data that's similar to it, nearby or where the person is looking. This has many potential applications from shopping to browsing through search results. Content on the screen that that doesn't appear to be getting the user's attention may be updated or removed.

Further user input may be entered through facial rendering, where the device 201 and its camera 113 are utilized to have a person perform facial expressions while recording and then using those facial expressions to create two-dimensional or three-dimensional representations of that, which can be enhanced or manipulated. One use case is regarding emojis where structure from the person's facial features is identified using a camera RGB depth sensing which is then used to create an image or likeness of the person. Similarly, the facial information and expressions may be used to perform 3D replacements and that can be over existing video content. Those 3D replacements could further be manipulated as well. In one example, if an already existing animation and the animation had a person with a face in it, the device 201 could record the user's face and infer some of the three-dimensional aspects and then replace the character's face in the existing animation with that of the user's. Also, if there were a limited camera input, the gyroscope and accelerometer may be used to record around the person's face to be able to synthesize the face from all angles for content creation.

In another example scenario, the various content generated by the input mechanisms described above may be auto shared. Content that the user generates, such as in a camera application or similar, may be analyzed and checked against criteria. If the criteria is met, the content may be shared in near real-time with people that are close to the user, in location, relation, or with whom they would likely wish to communicate with, or people that they have specified previously. An example embodiment would be: a user goes to a festival and takes a bunch of pictures of the festival, the subject matter in the photos may be analyzed such as with “machine learning” or “deep learning” or other analysis techniques, identifying things that are in the photo and then analyzing data for its “share-ability”. An example of this is if the subject matter that was in the photo is deemed to be something that the user would want to share or make public. If it was sensitive material or something that some people may find objectionable, then the system would know to not share that content with others.

Through a person's singular action of having taken a photo, there is much information available, including but not limited to: its location, its time, the date taken, subject matter, and then some details about the situation, setting, device. This information may be used to infer who the content can be shared with. The content can be automatically shared, it can be shared through the confirmation of the user, or can be suggested as being shared.

The content shared can be revoked, deleted, and other people can interact with the content that they've received through this method, such as by commenting, marking up, etc.

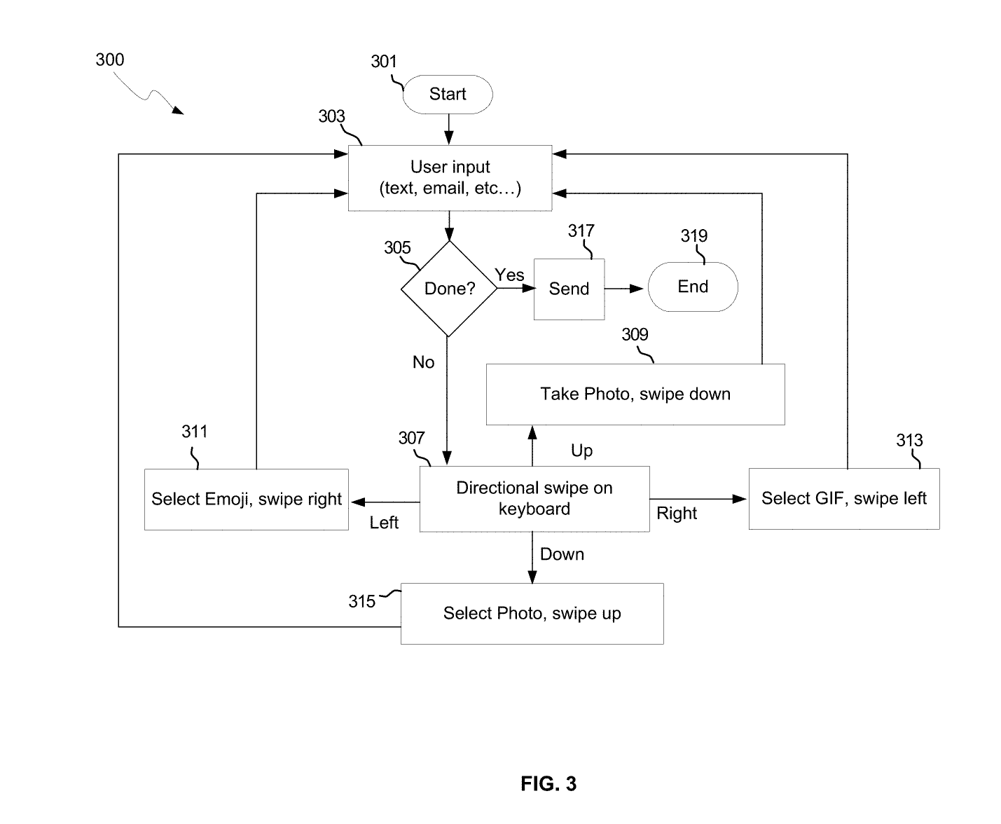

FIG. 3 is a flow chart for touchscreen keyboard directional swiping, in accordance with an example embodiment of the disclosure. The process flow is FIG. 3 may share any and all aspects of FIGS. 1 and 2 described previously. Referring to FIG. 3, there is shown keyboard directional swiping process flow 300 starting with start step 301 followed by step 303 where user input, such as opening up a text message or email application in a wireless device where an entry window is provided for the user to begin entry of information. In step 305, if the message entry is done, step 317 follows where the message is sent and finishes with end step 319.

Alternatively, if the message is not finished, the user may, in step 307, swipe in different directions to enter another entry mode in an alternative information entry screen. If the user swipes right, a GIF entry screen, for example, may be provided such that the user may select an appropriate GIF to be entered in the message in step 313 before swiping left to return to the text entry screen thereby returning to step 303 to continue composing the message.

In step 307, if the user swipes down, the photo library may be provided in step 315 where one or more photos may be selected for incorporation into the message before swiping up to return to the text entry screen thereby returning to step 303 to continue composing the message.

In step 307, if the user swipes up, the camera may be provided in step 309 where one or more photos may be taken for incorporation into the message before swiping down to return to the text entry screen thereby returning to step 303 to continue composing the message.

In step 307, if the user swipes left, an emoji selection window may be provided in step 311 where one or more emojis may be selected for incorporation into the message before swiping right to return to the text entry screen, thereby returning to step 303 to continue composing the message.

While left, right, up, and down linear swiping motions are described in this embodiment, the disclosure is no so limited, as other types of entry windows may be utilized, such as sound, video, etc. and in different directions, even in a diagonal direction. Similarly, other motions than a single linear swipe may be used, such as a circular motion, a “V” swiping motion, or an inverted V motion, for example.

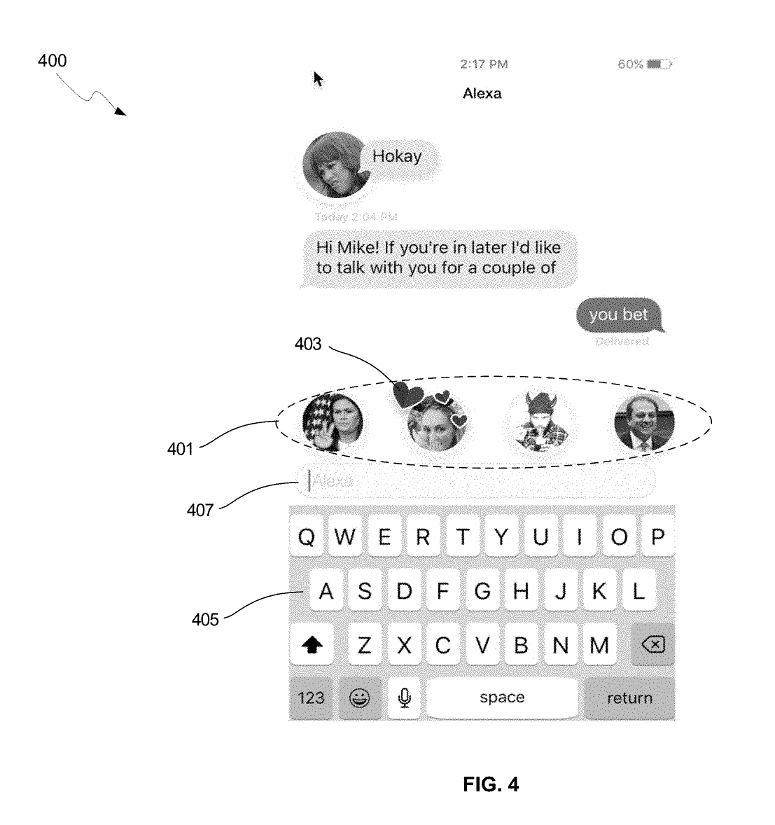

FIG. 4 illustrates a text entry screen with visual return buttons and mood indication, in accordance with an example embodiment of the disclosure. Referring to

FIG. 4, there is shown a messaging screen 400 with keyboard 405, information entry window 407, visual return buttons 401, and mood indicator 403.

The visual return buttons 401 may comprise images or GIFs, for example, to indicate the identity of a message recipient where selecting one of the buttons returns to the messaging conversation with that person. This is in contrast to existing messaging navigation where a back arrow returns to a list of messaging conversations. In an example scenario, the recipients shown may be based on most recent or most often messaged.

In addition, as discussed with respect to FIG. 2, a “mood” or “representation of emotion” visual aid may be incorporated on the messaging window 400 as indicated by the mood indicator 403. In this example, hearts have been inserted on the visual representation of a user, indicating a loving or fond mood being interpreted from the messages from that message recipient. Accordingly, machine learning and/or statistical methods may be utilized to extract features from the user's text and compared with a lexicon of words or phrases that the machine has learned or are associated with certain emotions or emotional states.

In an example embodiment of the disclosure, a method and system are described for enhanced touchscreen input and emotional expressiveness and may include, in a handheld communication device comprising a user input mechanism, a processor, and a display: receiving textual information in a message window via the user input mechanism; entering an alternative information entry screen based on a swipe across the user input mechanism; and inserting one or more elements of visual information into the message window based on a user selection.

The user input mechanism and display may comprise a touchscreen display. The alternative information entry screen may comprise a camera, graphics interface exchange (GIF), emoji, video library, audio clip, or photo library entry screen. The one of the camera, GIF, emoji, video library, audio clip, or photo library entry screens based on a direction of the swipe across the user input mechanism. The handheld communication device may switch back to textual information entry mode in the message window when the user input mechanism senses an opposite direction swipe by the user.

The message window may comprise a text messaging entry window. The swipe across the user input mechanism may comprise a linear motion in a horizontal or vertical direction on the user input mechanism. The swipe across the user input mechanism may comprise a curved motion on the user input mechanism or a circular motion on the user input mechanism. The textual information and inserted one or more elements of visual information may be communicated to a second handheld communication device.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
in a handheld communication device comprising a user input mechanism, a processor, and a display:
receiving textual information in a message window via the user input mechanism;
entering an alternative information entry screen based on a swipe across the user input mechanism; and
inserting one or more elements of visual information into the message window based on a user selection.

2. The method according to claim 1, wherein the user input mechanism and display comprise a touchscreen display.

3. The method according to claim 1, wherein the alternative information entry screen comprises a camera, graphics interface exchange (GIF), emoji, video library, audio clip, or photo library entry screen.

4. The method according to claim 3, comprising selecting one of the camera, GIF, emoji, video library, audio clip, or photo library entry screens based on a direction of the swipe across the user input mechanism.

5. The method according to claim 1, comprising switching back to textual information entry mode in the message window when the user input mechanism senses an opposite direction swipe by the user.

6. The method according to claim 1, wherein the message window comprises a text messaging entry window.

7. The method according to claim 1, wherein the swipe across the user input mechanism comprises a linear motion in a horizontal or vertical direction on the user input mechanism.

8. The method according to claim 1, wherein the swipe across the user input mechanism comprises a curved motion on the user input mechanism.

9. The method according to claim 1, wherein the swipe across the user input mechanism comprises a circular motion on the user input mechanism.

10. The method according to claim 1, comprising communicating the textual information and inserted one or more elements of visual information to a second handheld communication device.

11. A system for communication, the system comprising:
a handheld communication device comprising a user input mechanism, a processor, and a display, said handheld communication device operable to:
receive textual information in a message window via the user input mechanism;
enter an alternative information entry screen based on a swipe across the user input mechanism; and
insert one or more elements of visual information into the message window based on a user selection.

12. The system according to claim 11, wherein the user input mechanism comprises a touchscreen display.

13. The system according to claim 11, wherein the alternative information entry screen comprises a camera, graphics interface exchange (GIF), emoji, video library, audio clip, or photo library entry screen.

14. The system according to claim 13, wherein the handheld communication device is operable to select one of the camera, GIF, emoji, video library, audio clip, or photo library entry screens based on a direction of the swipe across the user input mechanism.

15. The system according to claim 11, wherein the handheld communication device is operable to switch back to textual information entry mode in the message window when the user input mechanism senses an opposite direction swipe by the user.

16. The system according to claim 11, wherein the message window comprises a text messaging entry window.

17. The system according to claim 11, wherein the swipe across the user input mechanism comprises a linear motion in a horizontal or vertical direction on the user input mechanism.

18. The system according to claim 17, wherein the swipe across the user input mechanism comprises a curved motion on the user input mechanism.

19. The system according to claim 11, wherein the swipe across the user input mechanism comprises a circular motion on the user input mechanism.

20. A system for communication, the system comprising:
a handheld communication device comprising a user input mechanism, a processor, and a display, said handheld communication device operable to:
receive textual information in a message window via the user input mechanism;
enter an alternative information entry screen based on a swipe across the user input mechanism;
insert one or more elements of visual information into the message window based on a user selection;
return to textual information entry in the message window based on a swipe in an opposite direction across the user input mechanism.
